(19) United States
(12) Patent Application Publication
(10) Pub. No.: US 2008/0298623 A1
(43) Pub. Date: Dec. 4, 2008

(54) Adapter For a Loudspeaker

(75) Inventors: Erich Klein, Himberg (AT); Michael Schoeffmann, Siegenfeld (AT)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/995,373

(22) PCT Filed: Jul. 13, 2006
(86) PCT No.: PCT/IB06/52388

§ 371 Date: Jan. 11, 2008

(30) Foreign Application Priority Data
Jul. 19, 2005 (EP) 05106597.7

(51) Int. Cl. H04R 1/10

(52) U.S. Cl. 381/380

(57) ABSTRACT

An adapter (3, 3′, 3″) for a loudspeaker (2) is disclosed, wherein the loudspeaker (2) is provided to be used in free space. The adapter (3) comprises means to provide an acoustic impedance on the backside (b) of the loudspeaker (2) in such a way, that an adaptation of the loudspeaker function from a free-space operation mode to an on-the-car or in-the-car operation mode is achieved.

### FIELD OF THE INVENTION

The invention relates to an adapter for a loudspeaker.

The invention further relates to a loudspeaker.

The invention finally relates to a device with a loudspeaker.

### BACKGROUND OF THE INVENTION

In-ear headphones, ear-phones or headphones respectively use electro-acoustic transducers to convert electrical signals into acoustic sound pressure. In this document the term “headphone” is used instead of the terms “in-ear headphones” and “ear-phones” to improve the readability of the text. Thus the term “headphone” means a headphone as well as an “in-ear headphone” or “ear-phone” in the context of the invention.

The electro-acoustic transducers mentioned above are usually loudspeakers with a special and defined design at their backsides to achieve an optimal sound reproduction when used in headphones.

Loudspeakers for the use in free field need other acoustic impedance on their backsides than speakers for use in headphones. Loudspeakers which are optimized for free-field sound reproduction have a poor “on-the-ear” or “in the ear” performance and vice versa. The term “free field” indicates that the sound produced by the loudspeaker is not emanated directly into a user's ear but into the free space between a user and the loudspeaker, whereas the terms “on the ear” or “in the ear” mean that sound produced by the loudspeaker is emanated essentially directly into a user's ear. To increase the readability of the text in the following the term “on the ear” will be used for the terms “on the ear” or “in the ear”.

With common headphones, which are provided for on the ear use, the acoustic impedance on the backside of the loudspeaker is either realized partly in the loudspeaker or in a headphone part in which the loudspeaker is used. The disadvantage of this solution is that the acoustic impedance necessary for an optimized headphone function has to be realized in the headphone part and/or in the loudspeaker. This limits the possibilities of designing the headphone. Furthermore, the loudspeaker is either optimized for a free-field use or for a headphone use. This is another major disadvantage since it is necessary to use different types of loudspeakers depending on the intended use of the loudspeaker, e.g. in the free-field or on the ear.

The document EP 1 401 236 A1 discloses an adapter for mounting a transducer on a housing of a device. The adapter comprises a first mounting part adapted to mount the adapter in the vicinity of an acoustically well-conductive part of the housing and a punctured part for enabling the passage of sound waves to/from the transducer from/to the exterior of the device. The adapter further comprises a second mounting part for mounting the transducer on the adapter. Further, the adapter includes load holes to stabilize the acoustical load caused by the loudspeaker. These load holes each constitute acoustic impedance. The sound produced by the transducer has to pass through the load holes when transmitted to the user's ear. However, this causes a major disadvantage of the known embodiment, since the frequency response of the speaker is affected due to the fact that the sound produced by the speaker has to pass the acoustic impedance of the adapter to get into the user's ear. It is a further disadvantage of the known embodiment that it is not possible to turn a free field speaker into a headphone speaker by means of the known adapter.

### OBJECT AND SUMMARY OF THE INVENTION

It is an object of the invention to provide an adapter of the type mentioned in the first paragraph, a loudspeaker as mentioned in the second paragraph and a device as mentioned in the third paragraph, in which the drawbacks described hereinbefore are avoided.

To achieve the object described above, characteristic features according to the invention are provided with an adapter according to the invention, so that an adapter according to the invention can be characterized as follows:

Adapter for a loudspeaker, which loudspeaker is provided to be used in the free space, the adapter comprising means providing an acoustic impedance on the backside of the loudspeaker in such a way, that an adaptation of the loudspeaker function is achieved from a free space operation mode to an on-the-ear or in-the-ear operation mode.

The inventive object is furthermore achieved by a loudspeaker with an adapter as invented and finally with a device with a loudspeaker as invented.

The provision of the characteristic features according to the invention creates the advantage that the acoustic function necessary for the speaker when mounted in a headphone is realized by means of the adapter. Since the acoustic function is realized with the adapter, a free field loudspeaker can easily be implemented in a headphone just by arranging the adapter on the backside of the speaker. Thus producing a headphone or a device comprising a loudspeaker is significantly simplified. Further the freedom of designing the headphone is increased significantly too, since it is no longer necessary to design the headphone housing according to the acoustic specifications required. It should be noted that the backside of the loudspeaker in the context of the invention is the whole surface of the loudspeaker except its sound emanating side.

It is now advantageous if the means providing an acoustic impedance are arranged opposite a sound emanating side of the loudspeaker in a mounted position of the adapter, because in this manner it is ensured in a very simple and effective way that the sound produced by the loudspeaker does not pass the acoustic impedance when being emitted to a user's ear. Moreover, the diameter of the adapter may have the same or even a smaller dimension than the loudspeaker, so that the total diameter of the arrangement is not increased compared to the loudspeaker itself.

It is further of advantage if the means providing an acoustic impedance comprise means providing acoustic friction. Thereby the sound reproduction is further improved.

Yet another advantageous embodiment of the invention is an adapter, wherein the means providing an acoustic impedance comprise a bass tube and/or openings and wherein each opening constitutes acoustic friction. These measures provide the advantage that the reproduction of low frequencies is significantly improved.

It is further beneficial if the bass tube and/or the openings are provided to connect a backvolume of the loudspeaker and the free space. Thus the bass reproduction is further improved.

Yet another advantageous embodiment of the invention is an adapter, which comprises means for mounting the loudspeaker in a device, because in this way the mounting of the speaker in a device is simplified. Thus an adapter as invented may serve both the purpose of the acoustic function and the mechanical function.

Finally it is advantageous if the adapter as invented comprises means for mounting the loudspeaker in a headphone. These measures provide the advantage that mounting the speaker in a headphone or earphone is significantly simplified, which in turn reduces costs for a headphone.

These and other aspects of the invention are apparent from and will be elucidated with reference to the embodiments described hereinafter.

### BRIEF DESCRIPTION OF THE DRAWINGS

The invention will be described in greater detail hereinafter, by way of non-limiting examples, with reference to the embodiments shown in the drawings.

FIG. 1 shows a headphone comprising a loudspeaker with an adapter according to the invention in a cross sectional view.

FIG. 2 shows a cross section along the line 11-H in FIG. 1.

FIG. 3 shows a second embodiment of the invention in a cross sectional view.

FIG. 4 shows a third embodiment of a headphone comprising a third embodiment of the invention in a cross sectional view.

FIG. 5 shows frequency responses of the headphone of FIG. 1 with and without adapter in a logarithmic scale.

FIG. 6 shows a free-field frequency response of the loudspeaker of FIG. 1 with and without adapter in a logarithmic scale.

The figures are schematically drawn and not true to scale, and identical reference numerals in different figures refer to corresponding elements. It will be clear to those skilled in the art that alternative but equivalent embodiments of the invention are possible without deviating from the true inventive concept, and that the scope of the invention will be limited by the claims only.

### DESCRIPTION OF EMBODIMENTS

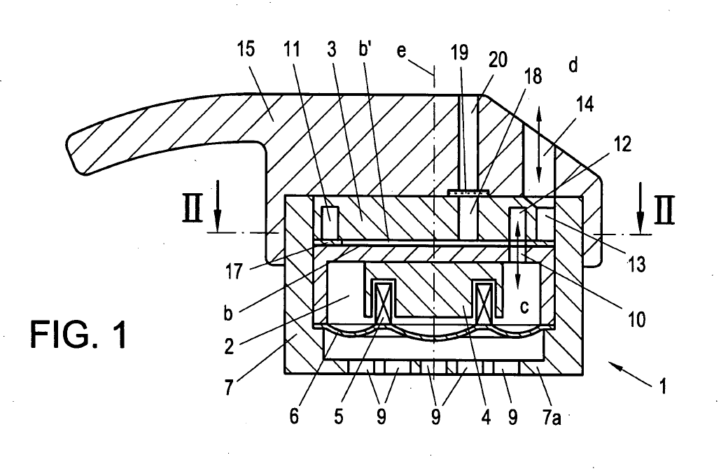

FIG. 1 shows a headphone 1 with a loudspeaker 2 and an adapter 3 according to the invention. The loudspeaker 2 is provided to be used in free space. This means the design of the loudspeaker 2 is optimized for a “free field” operation mode.

The adapter 3 provides acoustic impedance on the backside b of the loudspeaker 2 in such a way, that an adaptation of the loudspeaker function from the free field operation to an “on-the-ear” operation mode is achieved. In other words, the acoustic function of the loudspeaker 2 is optimized for an on the ear use by means of the adapter 3.

The loudspeaker 2 comprises a magnetic circuit 4 and a so-called voice coil 5 connected to a diaphragm 6. When an electrical signal is applied to the voice coil 5 via a cord, that is not shown here, the voice coil 5 causes the diaphragm 6 to oscillate and reproduce sound according to the electrical signal applied. On a sound emanating side of the loudspeaker 2 a front portion 7a of a front cover 7 of the headphone 1 is provided. The front portion 7a is arranged opposite to the diaphragm 6 and has a plurality of holes 9 through which sound waves emitted from the diaphragm 6 are made to pass.

The backside b of the loudspeaker 2 has one or more openings 10 connecting the back volume b′ of the loudspeaker 2 to the backside space c of the diaphragm 6.

The adapter 3 comprises means for providing acoustic impedance on the backside b of the loudspeaker 2. According to a preferred embodiment of the invention the means for providing the acoustic impedance are realized by means of a bass tube 11. In this case the adapter 3 carries the bass tube 11, wherein the bass tube 11 is connected to the back volume b′ of the loud speaker 2.

According to the embodiment shown, the bass tube 11 connects the back volume b′ of the loudspeaker 2 to the external space d outside the headphone 1. A first longitudinal end portion 12 of the bass tube 11 is connected to the opening 10, whereas a second longitudinal end portion 13 of the bass tube 11 is connected to the external space d outside the headphone 1 by means of an opening 14 in the cover part 15 of the headphone 1. In the section arranged between the two longitudinal end portions 12 and 13 the bass tube 11 is closed.

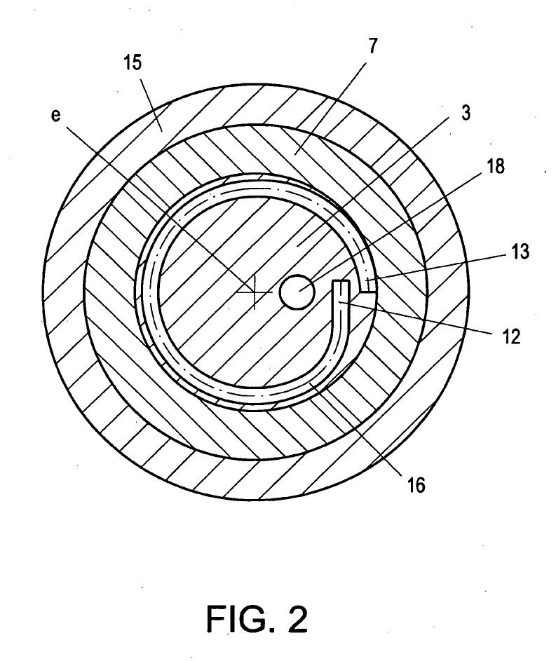

According to a preferred embodiment of the invention as shown in FIG. 2, the adapter 3 is realized as a plate with a U-shaped (with respect to its cross section) channel 16 for constituting the bass tube 11. The channel 16 is preferably arranged around the axis e of the adapter. However, in principle the channel 16 may be arranged on the adapter 3 in any other way too. So the channel 16 could transverse the adapter 3 along the surface of the adapter 3 or might have the shape of a meander or any other shape as well. Although the shape of the adapter 3 shown is circular, the adapter can in principle be of any other shape depending on the shape of the backside b of the loudspeaker 2, e.g. rectangular.

To form the bass tube 11 the channel 16 may be closed by means of a sealing ring 17 arranged on the backside b of the loudspeaker 2, as shown in FIG. 1. The sealing ring 17 may have the shape of a plate with a central opening.

According to another embodiment of the present invention, the channel 16 can be closed by a core plate or directly by means of the backside b of the loudspeaker 2 too. So the bass tube 11 or the adapter 3 respectively rests against the backside b of the loudspeaker 2.

It should be mentioned at this point that the adapter 3 could also be of a greater thickness, so that the bass tube 11 could also be arranged in a vertical manner inside the adapter 3. In the latter case the bass tube 11 could for instance have the shape of a helix arranged inside the adapter 3.

It should further be noted that the backside b of the loudspeaker 2 in the context of the invention is the whole surface of the loudspeaker 2 except its sound emanating side. Hence, in principle the adapter 3 may also have the shape of a ring (or even a cup), which encompasses the loudspeaker 2 and is arranged between the loudspeaker 2 and the headphone 1. In this case a bass tube 11 may be arranged around the outer diameter of the loudspeaker 2 and it may particularly have the shape of a helix running around the loudspeaker 2. The opening 10 may furthermore radially break through the loudspeaker housing. The advantage of this adapter is that the total height of the arrangement of the loudspeaker 2 and the adapter is not necessarily increased compared to the loudspeaker 2 itself. In contrast, the adapter 3 of FIG. 1 does not increase the total diameter of the arrangement of the loudspeaker 2 and the adapter 3 compared to the loudspeaker 2 itself. The latter embodiment is thus preferred if a loudspeaker 2 with a maximum diameter should fit into a user's ear.

The adapter 3 further comprises an opening 18 cooperating with the back volume b′. In the opening 18 or at the end of the opening 18 respectively, acoustic friction 19 is provided, e.g. by means of small holes or slits or by means of a canvas. The opening 18 corresponds with a channel 20 in the cover part 15 of the headphone 1. The back volume b′ is connected to the free space d by means of the opening 18 and the channel 20.

Preferably the adapter 3 is formed of a plastic material. Thus the adapter 3 can be easily produced as an injection molding part. Since the acoustic function for an on-ear use is realized by means of the adapter 3, which can be of a very slim shape, the freedom in choosing the visible design of the headphone 1 without impairing the acoustic function is significantly increased. The adapter can for instance be glued to the backside b of the loudspeaker 2.

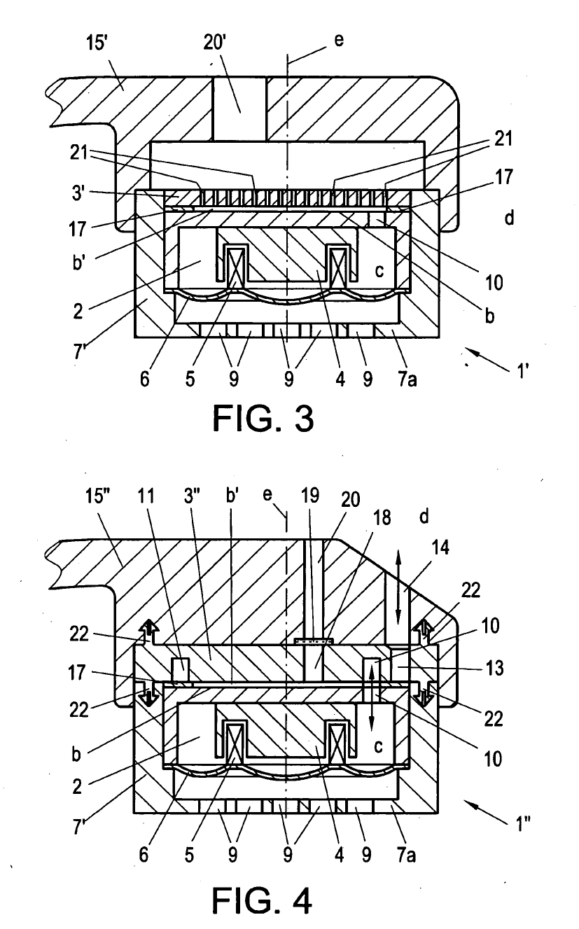

According to FIG. 3, the acoustic impedance on the backside b of the loudspeaker 2 is realized by means of holes 21 or slits in the adapter 3′. The holes 21 each constitute acoustic friction and connect the backspace b′ of the loudspeaker 2 to the external space d outside the headphone 1′ via an opening 20′ in the cover part 15′. The holes 21 have a cylindrical shape and each form a duct. According to a preferred embodiment of the invention the holes 21 have an approximate width of between 0.1 and 0.5 mm. The adapter 3′ is preferably made of plastic as well.

According to another embodiment of the invention shown in FIG. 4, the adapter 3″ comprises a means 22 for assembling the loudspeaker in a device, e.g. a mobile phone, a headphone or an in-the-ear headphone etc. This means may be realized as elastic lugs, which co-operate with a corresponding recess of the device. The elastic lugs can be snapped into the recesses.

In the embodiment shown, the lugs co-operate with recesses in the cover part 15″ or the front cover 7′ of the headphone 1″. According to another embodiment of the invention, the adapter 3″ may comprise only lugs co-operating with recesses of the device, e.g. a cover-part of the headphone, and is glued to the backside b of the loudspeaker 2.

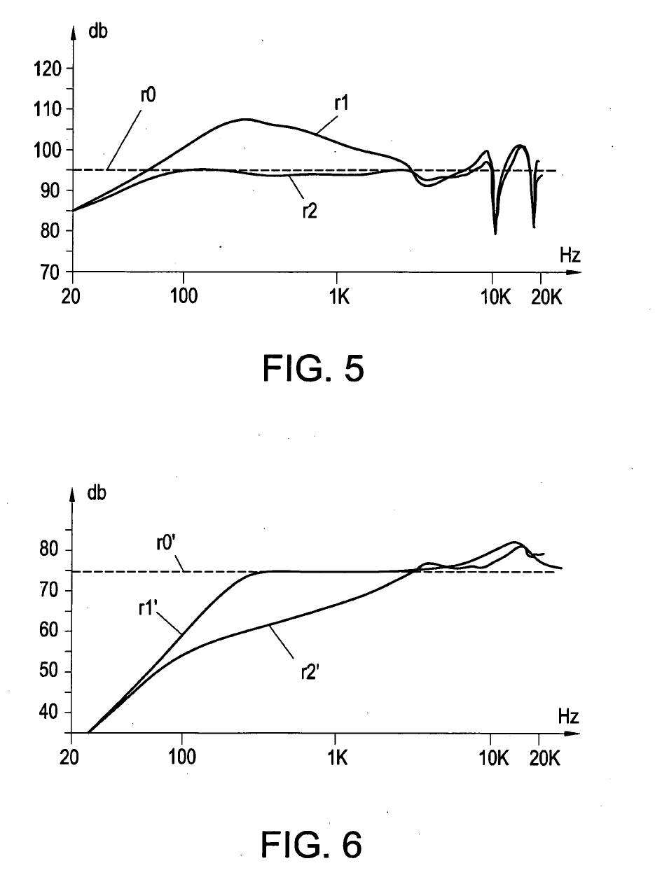

FIG. 5 now shows frequency responses for an on-the-ear use of the loudspeaker 2 with and without the adapter. The frequency response of the loudspeaker 2 without adapter 3, 3′, 3,″ is indicated by a graph r1. The frequency response of the loudspeaker 2 with adapter 3, 3′, 3,″ is indicated by a graph r2. The nominal frequency response for an on-the-ear use of the loudspeaker 2 is indicated by a graph r0.

As can be clearly seen, the graph r1 of the loudspeaker 2 without adapter strongly differs from the nominal frequency response r0 for an on-the-ear use. By means of the adapter 3, 3′, 3″ the frequency response T of the loudspeaker 2 is approximated to the nominal frequency r0 response for an on-the-ear use. Thus the loudspeaker 2, which is optimized for a free-field use, is adapted by means of the adapter 3, 3′, 3,″ for an on-the-ear-use.

FIG. 6 shows frequency responses of the loudspeaker 2 in a free-field use with and without the adapter 3, 3′, 3″. The frequency response of the loudspeaker 2 without adapter 3, 3′, 3″ is indicated by a graph r1′. The frequency response of the loudspeaker 2 with adapter 3, 3′, 3,″ is indicated by a graph r2′. The nominal frequency response for a free-field use of the loudspeaker 2 is indicated by a graph r0′.

As can be clearly seen in FIG. 6, the use of the adapter causes a huge deviation in the frequency response r2′ of the loudspeaker 2 from the nominal frequency response r0′ for a free-field use. If the adapter 3, 3′, 3″ is removed, the frequency response r1′ of the loudspeaker 2 approaches the nominal frequency response r0′ for a free-field use.

FIGS. 5 and 6 clearly show that a loudspeaker 2 that is designed for free-field use can easily be adapted for an on-the-ear use by means of the adapter 3, 3′, 3″.

It is a great advantage of the invention that the same type of loudspeaker 2 can be used when assembling a device, independently of whether the loudspeaker 2 is used for a free-field mode or an on-the-ear mode. By means of the adapter 3 it is very simple to adapt the acoustic function of the loudspeaker 2 according to the requirements when mounting the loudspeaker 2 in a device such as a mobile phone or headphone etc. without notably influencing the design of said devices. Thus producing different types of devices with different acoustic requirements is significantly simplified, since the same types of loudspeakers 2 can be used for these devices. So there is hardly any need to take the acoustic function into consideration when designing a new body structure of a headphone or mobile phone etc.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The words “comprising” and “comprises”, and the like, do not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage.

1. An adapter (3, 3′, 3″) for a loudspeaker (2), which loudspeaker (2) is provided to be used in the free space, the adapter (3, 3′, 3″) comprising means providing an acoustic impedance on the backside (b) of the loudspeaker (2) in such a way, that an adaptation of the loudspeaker function from a free space operation mode to an on-the-ear or in-the-ear operation mode is achieved.

2. An adapter (3, 3′, 3″) as claimed in claim 1, wherein the means providing an acoustic impedance are arranged opposite a sound emanating side of the loudspeaker (2) in a mounted position of the adapter (3, 3′, 3″).

3. An adapter (3, 3′, 3″) as claimed in claim 1, wherein the means providing an acoustic impedance comprise means providing acoustic friction.

4. An adapter (3, 3′, 3″) as claimed in claim 1, wherein the means providing an acoustic impedance comprise a bass tube (11) and/or openings (21), wherein each opening (21) constitutes acoustic friction.

5. An adapter (3, 3′, 3″) as claimed in claim 4, wherein the bass tube (11) and/or the openings (21) are provided to connect a back volume (b′) of the loudspeaker (2) and the free space (d).

6. An adapter (3, 3′, 3″) as claimed in claim 1, which comprises means (22) for mounting the loudspeaker (2) in a device.

7. An adapter (3, 3′, 3″) as claimed in claim 6, which comprises means (22) for mounting the loudspeaker (2) in a headphone (1, 1′, 1″).

8. A loudspeaker (2) with an adapter (3, 3′, 3″) as claimed in any one of the claims 1 to 7.

9. A device with an loudspeaker (2) as claimed in claim 8.

10. A device as claimed in claim 9, wherein the device is a headphone (1, 1′, 1″).
